(19) United States
(12) Patent Application Publication
(10) Pub. No.: US 2024/0182280 A1
(43) Pub. Date: Jun. 6, 2024

(54) LINKER COMMUNICATION WITH MULTIPLE LIFT SYSTEMS

(71) Applicant: Vehicle Service Group, LLC, Madison, IN (US)

(72) Inventors: Darian James Smith, Madison, IN (US); Robert Elliott, Madison, IN (US); Jahmai Turner, Shelbyville, KY (US)

(73) Assignee: Vehicle Service Group, LLC, Madison, IN (US)

(21) Appl. No.: 18/526,133

(22) Filed: Dec. 1, 2023

Related U.S. Application Data
(60) Provisional application No. 63/429,214, filed on Dec. 1, 2022.

(51) Int. Cl. B66F 3/46

(52) U.S. Cl. CPC B66F 3/46; B66F 3/24

(57) ABSTRACT

A vehicle lift system includes a plurality of lift groups, each lift group including a plurality of lift columns configured to lift a vehicle and a control device. The system further includes a linker module comprising a processor and a memory, wherein the memory is encoded with programming instructions executable by the processor to receive at least one user command from the control device of at least one of the plurality of lift groups, poll the control device of each lift group in the plurality of lift groups, determine, based on the polling, whether the received command can be executed, responsive to determining that the received command can be executed, send a custom instruction to each lift group to execute the received command, and responsive to determining that the received command cannot be executed, provide a notification to the user.

### PRIORITY

This application claims the priority to U.S. Provisional Pat. App. No. 63/429,214, entitled “Linker Communication with Multiple Lift Systems”, filed Dec. 1, 2022.

### BACKGROUND

Vehicle lift systems may be used to lift various kinds of vehicles relative to the ground. Some vehicle lift systems are formed by a set of mobile, above-ground lift columns. An example of a mobile column lift system is the MCHW18 Mobile Column Lift System by Rotary Lift of Madison, Indiana. The mobile columns may be readily positioned in relation to the vehicle, then be activated to lift the vehicle from the ground in a coordinated/synchronized fashion. The mobile columns may be controlled through wireless communication with a wireless controller associated with each mobile column in order to perform a synchronized lift. While a variety of systems and configurations have been made and used to control lift systems, it is believed that no one prior to the inventors has made or used the invention described herein.

### BRIEF DESCRIPTION OF THE DRAWINGS

While the specification concludes with EMBODIMENTS which particularly point out and distinctly EMBODY the invention, it is believed the present invention will be better understood from the following description of certain examples taken in conjunction with the accompanying drawings, in which like reference numerals identify the same elements, and in which:

FIG. 1 shows a schematic view of a lift system, in accordance with various embodiments;

FIG. 2 shows diagrammatic representation of the lift system of FIG. 1, in accordance with various embodiments;

FIG. 3 shows a perspective view of a remote controller, in accordance with various embodiments;

FIG. 4 shows a schematic view of two lift system subgroups combined, in accordance with various embodiments;

FIG. 5 shows a perspective view of a linker, in accordance with various embodiments;

FIG. 6 shows a perspective view of a linker, controller, and controller base, in accordance with various embodiments;

FIG. 7 shows a flowchart of a linker communication process, in accordance with various embodiments;

FIG. 8 shows another flowchart of a linker communication process, in accordance with various embodiments;

FIG. 9 shows a perspective view of two exemplary mobile lift columns, in accordance with various embodiments;

FIG. 10 shows a block diagram of the exemplary mobile lift system, in accordance with various embodiments;

FIG. 11 shows a block diagram of the exemplary linker system, in accordance with various embodiments;

FIG. 12 shows a block diagram of an example computing device that may perform some or all of the methods disclosed herein, in accordance with various embodiments.

The drawings are not intended to be limiting in any way, and it is contemplated that various embodiments of the technology may be carried out in a variety of other ways, including those not necessarily depicted in the drawings. The accompanying drawings, incorporated in and forming a part of the specification, illustrate several aspects of the present technology, and together with the description explain the principles of the technology; it being understood, however, that this technology is not limited to the precise arrangements shown.

### DETAILED DESCRIPTION

The following description of certain examples should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

### I. Column Lift System Overview

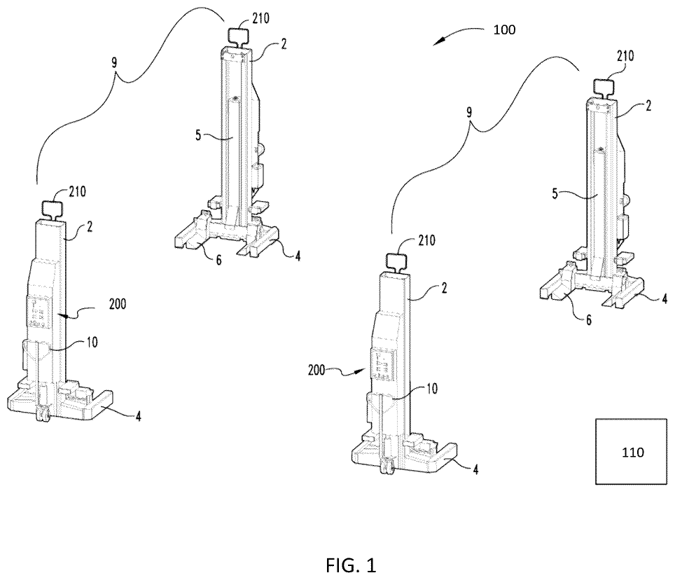

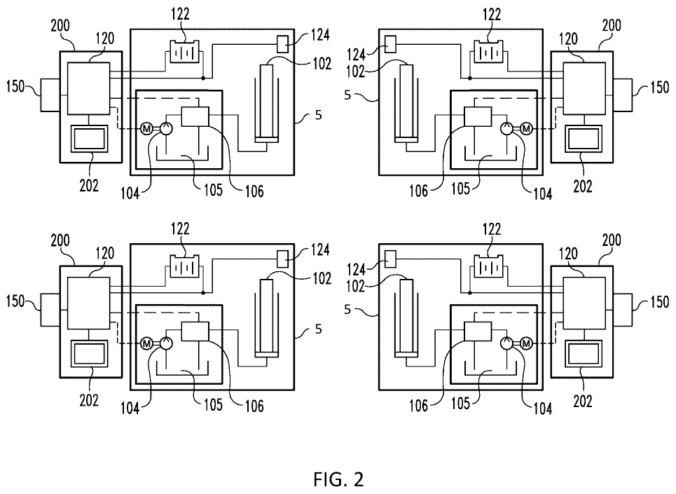

FIGS. 1 and 2 illustrate an exemplary lifting system (100) comprising a plurality of subgroups (9) and a centralized control module (110). In some embodiments, and as shown in FIG. 1, each lift subgroup (9) may comprise two mobile lift columns (2). In additional or alternative embodiments, the lift columns (2) may be one or more different lift types. By way of non-limiting example, the lift columns (2) may be stationary or mobile and may be configured as one or more of the following: a parallelogram type lift, a cylinder type lift, a scissor type lift, a screw lift, an in-ground or above-ground lift, or any other lift types as will occur to those skilled in the art.

In some embodiments, a control module (110) may be operable to control one or more lift columns (2) (e.g., to selectively raise or lower a vehicle relative to the ground). It should be understood that, while only two lift subgroups (9) and four lift columns (2) are shown, any other suitable number of lift subgroups (9) comprising any other suitable number of lift columns (2) (e.g., three, six, eight, etc.) may be used to form lifting system (100). In some embodiments, each lift column (2) may include a set of legs (4) that support the lift column (2) in relation to the ground. In a further embodiment, the lift columns (2) may also have wheels (not shown) and/or a handle (10), which permit the lift columns (2) to be moved or relocated (e.g., along the ground or floor surface). Accordingly, in a further embodiment, the lift columns (2) may thus be selectively positioned with relative ease, as may be desired to accommodate different vehicles having different wheel spacing or varying numbers and/or types of wheels (e.g., to move additional columns into place or to move excess columns away, etc.), to replace a first column with a second column for maintenance of the first column, etc.

In some embodiments, one or more lift columns (2) may further comprise a hydraulic system (5), which may be operable to move a carriage (6) vertically relative to the ground. The carriage (6) may be configured to engage a component of the vehicle (e.g., the wheel, etc.), to thereby raise and lower the vehicle relative to the ground. In some embodiments, and as shown in FIG. 2, each hydraulic system (5) of the present example may comprise a hydraulic cylinder and piston (102), a pump (104), and a series of valves (106) controlling the flow of hydraulic fluid stored within a reservoir (105). In a further embodiment, the pump (104) may have one or more valves (106) that are in fluid communication with the hydraulic cylinder and piston (102), such that pump (104) and valves (106) communicate fluid to or from the cylinder and piston (102).

Accordingly, in some embodiments, pump (104) and valve(s) (106) may, via the flow of hydraulic fluid, control the hydraulic cylinder and piston (102), thereby enabling the vertical height of the carriage (6) to be adjusted or positioned as required. In further embodiments, the ability of the carriage (6) to ascend and/or descend may be manual or automatic in nature. For example, in some embodiments, and as shown, a processor (120) may be in electrical communication with pump (104) and valve(s) (106), and using various control methods (e.g., relays, actuators, etc.), may be able to facilitate the operation of pump (104) and valve(s) (106). It should be understood that the description and figures presented herein are intended to be non-limiting, and any other suitable structures, components, or techniques may be used for or in a hydraulic system (5) as will occur to those skilled in the art.

Still referencing FIGS. 1 and 2, in some embodiments, each lift column (2) may further include a control interface (200), which may be used to control the operation, monitoring, and/or programming of a lifting system (100). For instance, control interface (200) may be used to define one or more column groups (9) comprising available lift columns (2). In a further embodiment, control interface (200) may also have a display (202) that is configured to provide the operator with one or more visual indications of which columns (2) have been assigned to which column group (9).

In another embodiment, display (202) may also include a graphical representation of a vehicle and/or graphical representations of the available columns (2) positioned in relation to the graphical representation of the vehicle. In some embodiments, the control interface (200) may illuminate one or more graphical representations of the available lift columns (2) that have been selected (e.g., for the column group (9)), providing the operator with immediate visual confirmation of which columns (2) have been selected and where those columns (2) are in relation to each other and the object to be lifted (e.g., the vehicle). The control interface (200) may alternatively or additionally illuminate the graphical representations of, or an indicator adjacent to, the position of the particular column (2) relative to the object being lifted. Control interface (200) may also be in communication with the processor (120), which is operable to process and relay information/commands to/from control interface (200).

By way of example only, control interface (200) may be configured and operable in accordance with at least some of the teachings of U.S. Pat. No. 8,083,034, entitled “Lift Control Interface,” issued Dec. 27, 2011, the disclosure of which is hereby incorporated by reference herein. As another merely illustrative example, control interface (200) and/or other aspects of lifting system (100) may be configured and operable in accordance with at least some of the teachings of U.S. Pat. No. 6,983,196, entitled “Electronically Controlled Vehicle Lift and Vehicle Service System,” issued Jan. 3, 2006, the disclosure of which is hereby incorporated by reference herein.

In some embodiments, and as shown in FIG. 2, a wireless transceiver (150) may also be provided at each column (2) and may be operable to wirelessly relay information and commands between that column (2) and a centralized control module (110) as will be described in greater detail below. It should be understood that the wireless transceiver (150) may take various suitable forms, including without limitation BLUETOOTH, WI-FI, ZIGBEE, and any other wireless transceivers and/or hardware which could be applied will be apparent to those of ordinary skill in the art in view of the teachings herein. As an alternative to wireless communication, cables may be used to provide wired communication of information/commands between each column (2) and centralized control module (110).

Each column (2) in some embodiments may further include a weight sensor (124) in communication with the corresponding processor (120). Weight sensor (124) may be attached to a column (2) in such a way as to measure the load on carriage (6). In a further embodiment, the processor (120) may be configured to detect sudden changes in the load on carriage (6) based on data from weight sensor (124). Thus, if processor (120) detects a sudden change in the load on carriage (6) based on data from weight sensor (124), processor (120) may signal an error message to control module (110), which could further transmit the error message to all other columns (2). In response to this error message, the system (100) may change to a secure, stopped state of the carriages (6) to prevent unintended raising or lowering. This feature may be utilized in case an object obstructs system (100) from raising or lowering a vehicle. This feature may also be utilized if there is a sudden shift in loads between different columns (2) in system (100). This feature may be utilized in any suitable manner apparent to one having ordinary skill in the art in view of the teachings herein.

In some embodiments, each lift column (2) further includes an indicator (210) connected with control interface (200). Indicator (210) may include a light, a speaker, or any other suitable form of communication to signal a message or information to those in the vicinity of lift column (2). Indicator (210) may be activated in response to information delivered from various kinds of sensors, such as weight sensor (124) on column (2) or various commands from a control module (110). Accordingly, indicator (210) may be activated based on information that a control module (110) sends to the interface (200). In a further embodiment, the columns (2) may be configured to automatically stop raising or lowering carriage (6) at a specified height, such as eight inches or two feet. In some embodiments, a foot switch or other intentionally activated release may be required in some embodiments to lower columns (2) past the point where columns (2) are configured to automatically stop.

As also shown in FIG. 2, each column (2) may include a respective battery (122). Batteries (122) in the illustrated embodiment may be rechargeable and are operable to power all aspects of operation of their respective columns (2). In particular, each battery (122) may be operable to power the pump (104), control interface (200), indicator (210), weight sensor (124), transceiver (150), and any other electrically powered component in each column (2). By way of example only, such operability may be provided in accordance with at least some of the teachings of U.S. Pat. No. 11,305,972, entitled “Vehicle Lift with Locally Stored Energy Source,” the disclosure of which is hereby incorporated by reference herein.

In an additional or alternative embodiment, at least part of each column (2) may receive power from an external source via one or more wires or in some other suitable fashion. In a further embodiment, each column (2) may receive power via one or more wires from another column (2) to form a chain (i.e., daisy chain) of columns, while one column (2) receives power from an external power source via one or more wires, and all other columns receive power from the external power source indirectly via the chain of columns connected to each other via wires.

In various embodiments, system (100) comprises a lock mechanism that can hold each carriage (6) of each column (2) from traveling down in various scenarios where that downward motion is undesirable. For example, in some systems, a centralized control module (110) can receive a user command to lower the carriage (6) of each column (2) to a position where the weight of the vehicle is being supported mechanically by the structure of column (2) rather than the hydraulic lift system. Likewise, centralized control module (110) may receive a user command to raise the carriage (6) of each column (2) out of the locked position so that the hydraulic system again supports the weight of the vehicle. In some embodiments, this locking/unlocking functionality is structured as described in U.S. Pat. No. 9,678,821, filed on May 6, 2015, and titled “Load Indicator for Vehicle Lift,” while other implementations and embodiments will occur to those skilled in the art in view of this disclosure.

As described above, one or more life columns (2) may be configured to be in a fully locked position when carriage (6) has been lowered to fully engage a locking assembly (not shown). When in this position, the hydraulic fluid in hydraulic cylinder (5) may be at least partially relieved of pressure. In other words, the load carried by column (2) may be shifted from being supported by a hydraulic cylinder (5) to being at least partially supported by a locking assembly (not shown). In this mode of operation, pressure in hydraulic cylinder (5) and the rest of the hydraulic circuit may act to indicate whether column (2) is in a locked state. When the pressure in the hydraulic circuit is relatively high, this may indicate that the hydraulic circuit is bearing the weight of the lifted vehicle, which may further indicate that column (2) is in an unlocked state. When the pressure in the hydraulic circuit is relatively low, this may indicate that the mechanical components of locking assembly (not shown) are bearing the weight of the lifted vehicle, which may further indicate that column (2) is in a locked state.

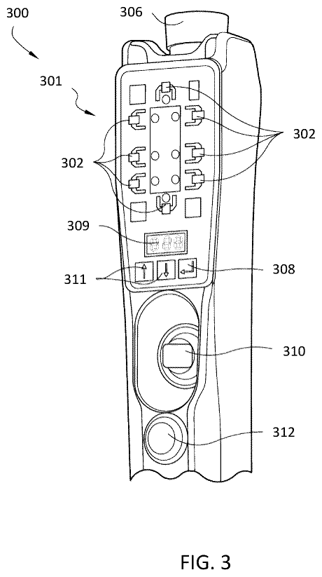

Referring now to FIG. 3 an exemplary remote control (300) may be used in the same or similar manner as control module (110), though with additional functionality. Similar to control module (110), remote control (300) may house a processor (not shown), a wireless transmitter (not shown), and a battery (not shown). The battery may power the remote control (300) and may be in direct or indirect electrical communication with the processor and wireless transmitter. In some embodiments, the processor and wireless transmitter may be in communication with each other as well as physically and/or operationally substantially the same as the processor and wireless transmitter mentioned above. Therefore, remote control (300) may be capable of communicating with wireless transceivers (150) and processors (120) of control interface (200) to control a column (2) or group (9) of columns (2) in the system (100) or one or more subgroups (9).

In a further embodiment, remote control (300) may also include its own interface (301) to allow for user input to control system (100). Interface (301) may have any or all of a plurality of column avatars (302), a power button (304), an E-stop button (306), a numeral display (309), numeral controls (311), a numeral selector (308), actuation control (310), and re-activation (“wake”) button (312), along with other controls as will occur to those skilled in the art in view of this disclosure.

In some embodiments, numeral controls (308) may be capable of scrolling through a set of numbers shown on numeral display (309), while numeral selector (308) allows an operator to choose (that is, complete entry of) a displayed number. Numeral selector (308) may perform various functions, some of which may apply to initially setting up system (100). Such functions may include designating a broadcast channel through which wireless transceiver will communicate or selecting the number of columns (2) to associate with system (100).

In the present example, numeral display (309) is an LCD screen, while numeral controls (311) and numeral selector (308) are a plurality of buttons. In an additional or alternative embodiment, numeral display (309), numeral controls (311), and numeral selector (308) may all be located on a touch screen display, knob, or any other suitable means known to a person having ordinary skill in the art in view of the teachings herein. In a further embodiment, actuation control (310) may allow a user to selectively actuate one or more columns (2) within system (100). Actuation control (310) may include a dynamic switch, giving a user the capability to determine the speed at which selectively actuated columns (2) raise or lower based on displacement of actuation control (310) from an off position.

In some embodiments, the valve (106) and pump (104) discussed herein may be configured to adjust their speed/movement to proportionally match the movement of actuation control (310). For example, if a user wishes to raise or lower selected columns (2) in system (100), a user may manipulate actuation control (310) in a direction associated with raising or lowering selected columns (2), and the farther from a rest position the manipulate actuation control (310) is moved, the faster the selected columns (2) move. In a further embodiment, the user may manipulate actuation control (310) varying distances and/or with varying degrees of force to adjust the speed at which the selected columns (2) lift or lower.

It should be understood that actuation control (310) may signal a processor (or microcontroller) to generate the information associated with raising or lowering selected columns (2), which is then transferred from the remote control (300), via a transceiver, to one or more transceivers (150) of columns (2). Moreover, transceivers (150) may then send this information to processors (120) of columns (2), which use this information to raise or lower that column (2). It should further be understood that actuation control (310) may be set up with a joystick control, a sliding-switch control, a sliding graphic on a touch screen, or any other control method that would occur to a person having ordinary skill in the art in view of the teachings herein.

In some embodiments, column avatars (302) may be configured to light up in order to graphically represent individual columns (2). Graphical representation of individual columns could be used to show that individual columns (2) have been activated or are (or are to be) incorporated into system (100). Additionally, any other suitable need for graphical representation of individual columns could be met as would occur to a person having ordinary skill in the art in view of the teachings herein. Such as, for example, when a user is initially setting up system (100), the column avatars (302) may be configured to help instruct a user which column (2) in the system (100) needs to be activated in order to help the system (100) understand the location of column (2) relative to the vehicle or other object being lifted. Thus, a column avatar (302) may light up with respect to the column (2) associated with the front axle on the driver's side of the vehicle being lifted, which would then allow a user to activate the column (2) at the front axle on the driver's side.

In some embodiments, users can operate configuration interface elements on interface (200) of each column (2) to configure the columns (2) in system (100) without necessarily interacting directly with centralized control module (300). In such embodiments, the user might use interface (200) on a particular column (2) to select channels, select quantities of lifts, indicate positions, and the like, and that column (2) would then transmit the data to centralized control module (300) and/or the other columns (2). The rest of the setup and operation procedures could proceed as described elsewhere herein.

Remote display (301) may illustrate information to a user, such as which channel ID or frequency the controller (300), or controller antenna, is operating on, the current lift status of the mobile lifting system (100), whether controller (300) is operable to control mobile lifting system (100), a remote battery indicator, a wireless connection strength indicator, or any errors (such as communication errors) that the system may be encountering. In some embodiments, the controller (300) may also have a set of indicators (not shown), such as LEDs, each indicator being configured to indicate the current connection status between the remote and each lift column of the set of lift columns (9) or the connection status between the controller (300) and each set of lift columns (9) of the mobile lifting system (100). Each indicator may indicate the presence or non-presence of a connection by either illuminating, not illuminating, or illuminating using a distinct color (e.g., amber=not connected, green=connected) or pattern (e.g., solid=connected, off=not connected, flashing in a particular pattern=particular phase of connecting). In embodiments where the system 100 includes a consensus button (described below), the set of indicators may also include an indicator reflecting whether the consensus button is pressed.

In some embodiments, the controller (300) may include an Emergency Stop “E-stop” (306) that allows a user to stop actuation of columns (2) in system (100). When pushed, E-stop (306) may shut off pump (103). Alternatively, E-stop (306) may divert hydraulic fluid pressurized by pump (103) into reservoir (105) rather than into hydraulic cylinder and piston (102). In some embodiments, reactivation button (312) allows a user to reactivate remote control (300) after it is turned off or made dormant after a predetermined period of inactivity.

### II. Grouping Column Lift Systems

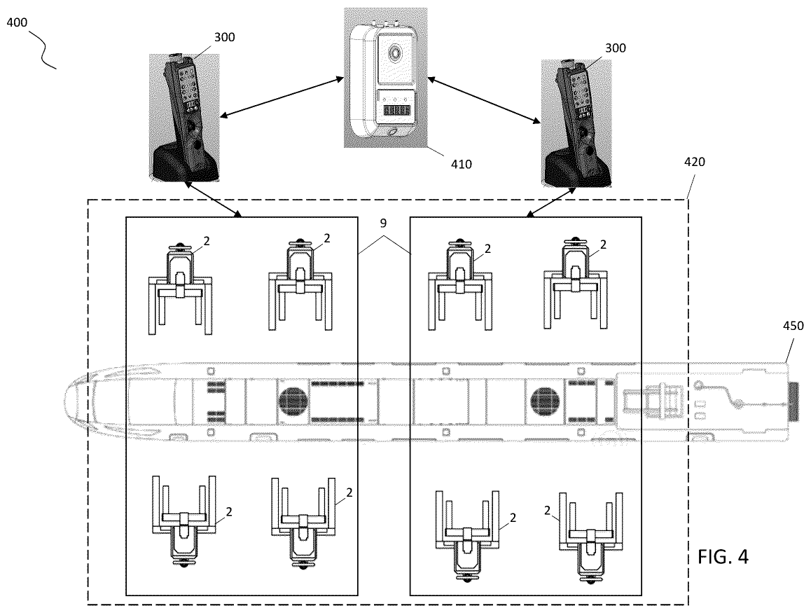

As discussed herein, two, four, six, eight, or some other number of lift columns (2) may be combined to form a column lift subgroup (9). However, as also discussed herein, occasions may arise in which coordination among a great number of lift columns is needed (e.g., to lift a train car (450)). Accordingly, in some embodiments, and as shown in FIG. 4, two or more column subgroups (9) (e.g., column groups consisting of more than one but not more than nine columns) may be linked together as will now be described. With continuing reference to FIG. 4, an illustrative embodiment is shown of a grouping of lifting systems (400), which, in some embodiments, may include a linker (410), multiple sets of lift columns (9), and a controller (300) for each subgroup of lift columns (9). Each controller (300) may be associated with a set of lift columns (9) and can be configured to instruct and communicate data with each lift column (2) of the set of lift columns (9). As will be described below, each controller (300) can be configured to communicate with linker (410) to receive and provide instructions and lift data. Once all or a select number of controllers (300) are in communication with the linker (410), a controller (300) may be operable to control each lift column (2) of each set of lift columns (9) of the lifting system (400) such that the combined groups of lift columns (420) can operate in unison to lift a longer vehicle (450).

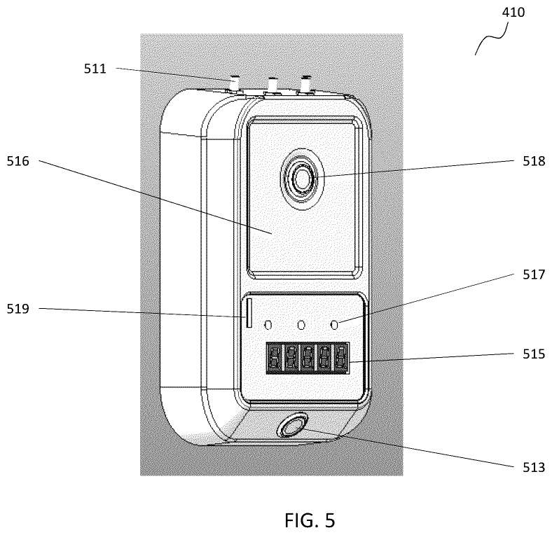

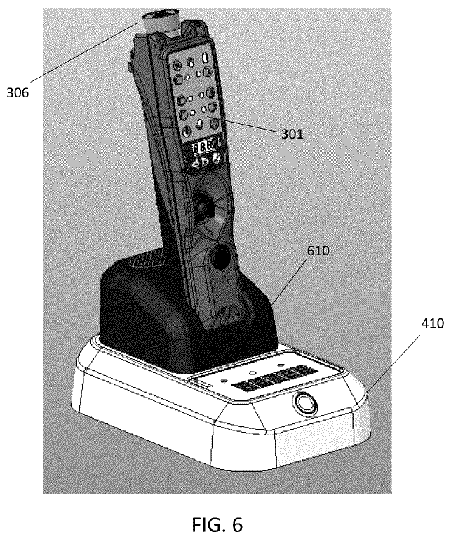

Referring now to FIGS. 5 and 6, an exemplary linker (410) may, as shown, include a consensus button (513), a linker display (515), multiple lift set indicators (517), a command button (518), a reset or reprogram button (519), and/or a remote base recess (516). In some embodiments, linker (410) may be mounted to a flat, horizontal surface, such as a table or shelf, or, alternatively, to a flat, vertical surface such as a wall or beam, by using included wall mounts (not pictured) capable of fixing linker (410) to a horizontal, vertical, angled, or other surface. In a further embodiment, linker (410) may include or make attachable one or more linker antennae (511) and/or a foot pedal (not shown), either or both of which may be coupled for communication with linker (410). In some embodiments, linker antennae (511) may be useful to increase the range of linker (410) when communicating with a peripheral device. In an additional or alternative embodiment, the foot pedal may be used as or pressed in lieu of pressing consensus button (513). In another embodiment, and as shown in FIG. 6, an exemplary controller (300) may be affixed to a remote base (610) positioned on a linker (410). Controller (300) may be detachable from remote base (610) such that a user may control various aspects of lifting system (100) while controller (300) is away from remote base (610).

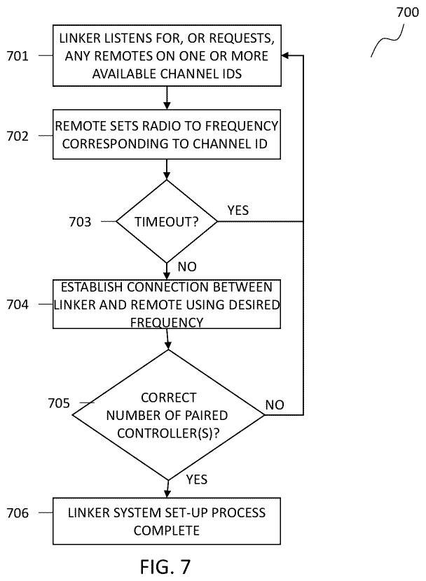

Referring now to FIG. 7, an exemplary process (700) is shown for setting up (configuring) a linker (410) to communicate with multiple remotes (300) and thereby control multiple lift subgroups (e.g., (420) of FIG. 4) as a single unit. In some embodiments, and as shown, the linker (410) may, via one or more remotes (300), communicate with each lift column in order to lift or lower the vehicle (450). In other embodiments (not shown), the linker (410) may communicate directly with each lift column in order to lift or lower the vehicle (45). This process will be explained in detail along with illustrations of exemplary embodiments of components that may be used in the process (700).

In some embodiments, and as shown, the linker (410) may, automatically or responsively to user input, listen for or actively request (e.g., poll for) (701) updates from one or more remote controllers (300) (e.g., on one or more available channels) by selecting an appropriate channel ID on the linker (410). Once one or more remote controllers (300) are identified, the remote controller may then, automatically or via user input, set (702) its radio frequency to the corresponding channel ID selected by the linker. The radio frequency may be selected according to a transmission factor such as one or more of a user preference, an evaluation of potential radio frequency interference, a total number of lift groups, a total number of control devices, bandwidth usable in a particular frequency band, and historical metrics associated with a particular frequency band. It should be understood that the steps presented in process (700) are for illustrative purposes only and that various alternative connection methodologies may be used. For example, in one embodiment, the linker (410) may provide the one or more controllers (300) with a desired or required frequency (or channel ID), whereas, in an alternative embodiment, the one or more controllers (300) may provide the linker (410) with its desired or required frequency (or channel ID).

Regardless of connection method, once the linker (410) and/or the controller (300) have identified a radio frequency and/or channel ID, a connection is established (704) using the identified radio frequency. In some embodiments, it may be possible for a “timeout” (703) or connection error to occur. If an error or timeout occurs, the system (e.g., linker (400)) may notify the user (e.g., via the controller display (301) or the linker display (515)). In another embodiment, the linker (410) and controller (300) may automatically attempt to reconnect (e.g., using the same channel ID/frequency or an alternative channel ID/frequency). Should a timeout occur, the system (400) may need to determine whether a linker (410) is required to be in communication with one or more remote controllers (300). This determination may be made automatically (e.g., by evaluation of one or more metrics, such as if the object to be lifted requires more than eight lift columns) or by a user input on the controller (300) or linker (410). If it is determined that a linker (410) is required to be in communication with controller (300), further listening/polling (701) may be performed until communication is established.

In some embodiments, after at least one controller (300) connects to (e.g., pairs) (704) with a linker (410), a determination (705) may be made (e.g., by the controller (300) or the linker (410)) regarding the total number of groups (e.g., subgroups (9)) that are linked together, using the linker (410). If it is determined that more lift columns are required (and thus more subgroups) the process (700) may return to listening/polling (701) for additional available remote controllers. If it is determined that all the required lift subgroups are connected, the linker system setup process is complete (706). Although not shown, it should be understood, as described above, that the controllers (300) that are connected to the linker (410) will also be connected to one or more lift columns (2).

Thus, as discussed herein, in some embodiments, a controller (300) may allow, or prompt, a user to select a column configuration (e.g., as discussed in connection with FIG. 3 and the column avatars (302)). In some embodiments, a user may select a desired column configuration (e.g., from a set of column configurations). Controller (300) may then begin a process of pairing with each column (2). Once all lift columns (2) are paired with their respective controller (300), the linker (410) process is complete (706).

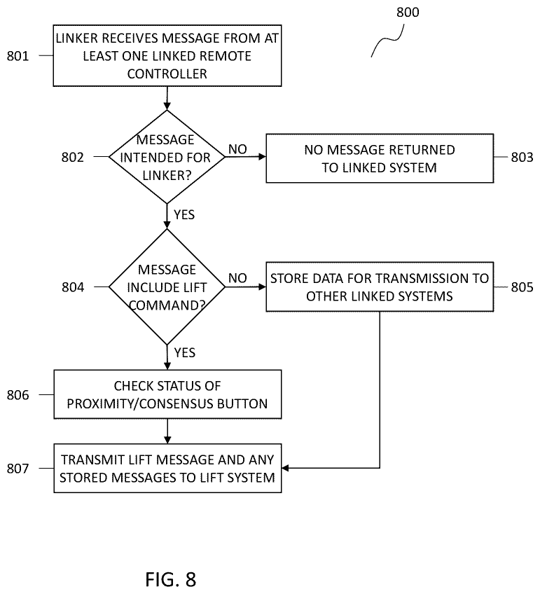

Referring now to FIG. 8, an exemplary process (800) for communicating with multiple subgroups (9) of lift columns is presented. After the setup process (700) is complete (706), the linker (410) may receive (801) a message from at least one controller (300). The message may reach the linker (410) due to the linker (410) listening for, or actively requesting (e.g., polling for), information from the at least one controller (300). As disclosed herein, messages may be passed back and forth between the linker (410) and the controllers (300) related to various factors, such as, for example, the status of each lift under the control of a specific controller (300), the number of columns (2) in a particular subgroup (9), commands for a specific lift column (2), commands for one or more subgroups (9), and the like.

It should be further understood that in some embodiments the commands for a specific lift column (2) or specific subgroup (9) may be commands for lifts (2)/subgroups (9) controlled by the specific controller (300) or may be commands for lifts (2)/subgroups (9) controlled by a different controller (300) (e.g., a different controller (300) that is linked to the linker (410)). Stated differently, and briefly referring to the embodiment shown in FIG. 4, although each subgroup (9) is assigned and in direct communication with only one specific controller (300), in some embodiments, either remote controller (300) (e.g., the one on the left or the one on the right) of the two remote controllers may issue commands to the lifts (2) in either subgroup (9) by passing the communication through the linker (410) and to the controller (300) assigned to the specific lift (2)/subgroup (9) that is to be controlled.

Thus, in some embodiments, the process (800) may include determining (802) whether the message received at the linker (410) from a controller (300) is intended for the linker (e.g., was a command intended to be passed to another controller (300) to control a lift (2) outside of the subgroup (9) of the sending controller (300)?). In some embodiments, if the message is not intended (802) for the linker (410), it may be discarded or stored, but it is not passed (803) on to the other linked subgroups (9)/controllers (300). On the other hand, if the command is intended (802) for a different controller (300) or subgroup (9), the system may determine (804) whether the message includes a lift command. As discussed herein, a lift command may be issued from any controller (300) connected to the linker (410), which may then be relayed to the remaining controller/subgroups as needed.

In at least one embodiment, once a message is determined (802) to be intended for the linker (410), it is further evaluated (804) to determine whether a lift command was issued. If no lift command was issued (804), the system may store (805) the data for transmission to the other linked systems at a later time. It should be understood that alternative embodiments may exist, such as, for example, the system may, after determining (804) that the message did not include a lift command, still pass the command to the other desired lifts (2)/subgroups (9). In some embodiments, the system may be capable of both modes of performance (i.e., storing the data or immediately sending the data) and may make the determination based on the available bandwidth of the relevant portions of the system, the current mode or action of lifts (2), subgroups (9), or controllers (300), or other factors as will occur to those skilled in the art in view of this disclosure.

If the message is intended (802) for the linker (410) and includes (804) a lift command, a check of the proximity switch and/or consensus button (513) may be conducted (806). If the consensus button and/or proximity sensor are activated (806), the system may transmit (807) the lift command and any other stored messages to each controller (300) linked to the linker (410). In some embodiments, a determination (not shown) may be made whether a lift column (2) is in already in motion. In some embodiments, the linker (410) may be able to request and receive a height status of each lift column (2) to determine whether any lift column is leading or lagging relative to any other lift column. If it is determined that one or more lift columns (2) are out of line with the group, a corrective action may be taken, including, but not limited to, ceasing all lift movement on the combined groups of lift columns (420), lowering all lifts in the combined groups of lift columns (420), automatically adjusting for the determined offset, and providing a notification (e.g., visual, auditory, haptic, etc.) to a user.

In some embodiments, the message received (801) by the linker (410) may contain lift analytic data. In that embodiment, the linker (410) may reformat the data for transmission to an analytics repository (e.g., on a remote server). In a further embodiment, the linker (410) may also determine whether it is connected to a remote server (not shown) and if so, transmit the data to the remote server. Alternatively, if the linker (410) is not connected to a remote server, it may store the data in local memory and check for or initiate a connection with a remote server on a periodic basis.

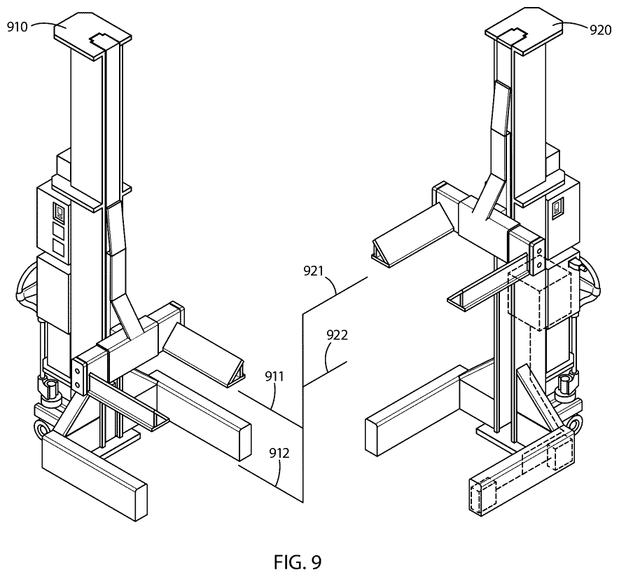

Referring now to FIG. 9, an illustrative example of two lift columns (910, 920) is shown. In some embodiments, and as shown, the desired positions of two lift columns (910, 920) may result in their legs (4) being offset (911, 921). In some embodiments, offsetting one lift column (910) relative to another lift column (920) may be desirable if the different lift columns (910, 920) begin lifting a vehicle at different heights. By way of non-limiting example, one lift column (910) may lift from a vehicle wheel starting at a ground level (912) while a different column lift (920) may need to lift from contact with the vehicle's frame at a height (922) above ground level. In order for the lift columns (910, 920) to lift the vehicle evenly and uniformly, the determined offset (e.g., the distance between the ground (912) and the frame lift point height (922)) must be accounted for.

In some embodiments, the offset may be defined as the starting height (922) of the lift column (920) relative to the other lift column (910) because the difference can be determined as the initial height (922) relative to ground level (912). In some embodiments, the offset may be preprogrammed or predetermined based on the application (e.g., object/vehicle to be lifted) and may be communicated to each lift column (910, 920). In another embodiment, the offset may be determined for each application by advancing each lift column (910, 920) in an upward direction until a predefined load is detected, thereby determining the desired offset for each lift column (910, 920). Controllers (300) and linker (410) then cooperate to maintain that offset between the lift columns (910, 920) until work on that vehicle is complete (e.g., until all lifts are returned to ground level).

Other lift-specific data may be known and/or utilized in a manner similar to the lift offset. Thus, in some embodiments, lift data may include anything related to the operation or status of any aspect of one or more lift columns (2), subgroups (9), or lifting system (400). Non-limiting examples of said lift data may include individual lift column (910, 920) ground position, velocity, acceleration, target location, distance to target location, vehicle location and position relative to vehicle location, hydraulic pressure, or other property as will occur to those skilled in the art in view of this disclosure. In some embodiments, lift data may also include data regarding lift column (910, 920) lift arms including, but not limited to, lift arm height, lift arm velocity, lift arm acceleration, lift arm offset, lift arm extension position, and the like. Lift data may also include lift column battery status, currently lifted weight, any malfunctions/errors, percentage lifted of total vehicle weight, percentage of total lift height achieved, and the like.

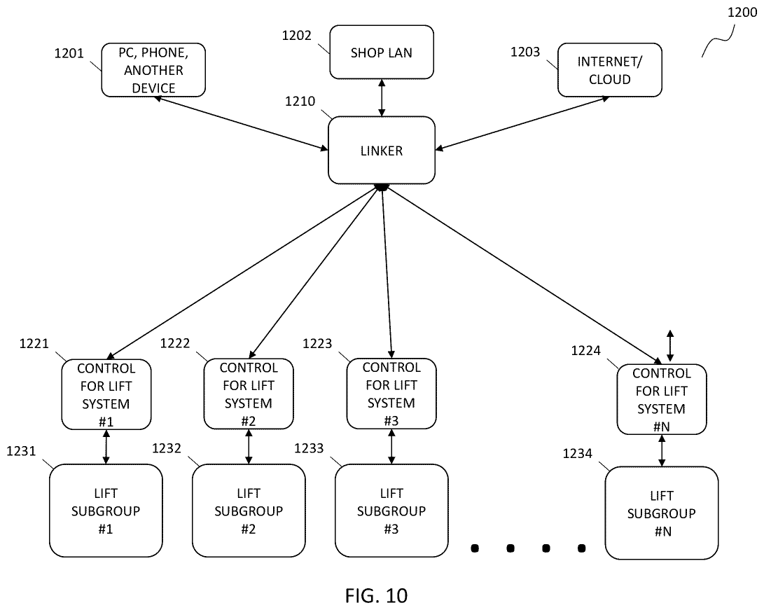

FIG. 10 shows a diagrammatic representation of lifting system (1200). Lifting system (1200) may include multiple sets of lift column subgroups (1231, 1232, 1233, 1234). In some embodiments, each set of lift column subgroups (1231, 1232, 1233, 1234) may be operable to communicate with its respective controller (1221, 1222, 1223, 1224). As discussed herein, the controllers (1221, 1222, 1223, 1224) may be operable to communicate with the linker (1210). Thus, each controller (1221, 1222, 1223, 1224) (like, for example, remote controller (300)) can be operable to communicate lift data between an associated set of lift column subgroups (1231, 1232, 1233, 1234) and the linker (1210) as described above. In alternative embodiments (not shown), a single controller (e.g., controller (1221)) may be operable to communicate with all sets of the lift column subgroups (1231, 1232, 1233, 1234) or with a single lift column subgroup (e.g., lift column subgroup (1231)) that includes all lift columns (2).

In an additional or alternative embodiment (not shown), the lift column subgroups (1231, 1232, 1233, 1234) may be able to communicate directly with linker (1210). In a further embodiment, linker (1210) may be operable to communicate associated lift data between a set of lift column subgroups (1231, 1232, 1233, 1234) and one or more controllers (1221, 1222, 1223, 1224). In another embodiment, the linker (1210) may also be able to communicate with a PC, phone, tablet, or other device (1201), a local area network (1202) (e.g., shop LAN), or the internet/cloud (1203). In some embodiments, the linker (1210) may be capable of transmitting and receiving any associated lift data between any element or system component (e.g., 1201, 1202, 1203, 1221, 1222, 1223, 1224, 1231, 1232, 1233, and 1234) and may also be capable of directly communicating with any individual lift column (2) among the set of lift columns (1231, 1232, 1333). A PC, LAN, and/or external network (1201, 1202, 1203) may be in indirect or direct communication with the set of lift column subgroups (1231, 1232, 1233, 1234) or a lift column (2) to receive lift data or to transmit lift instructions for lifting or lowering vehicle (450).

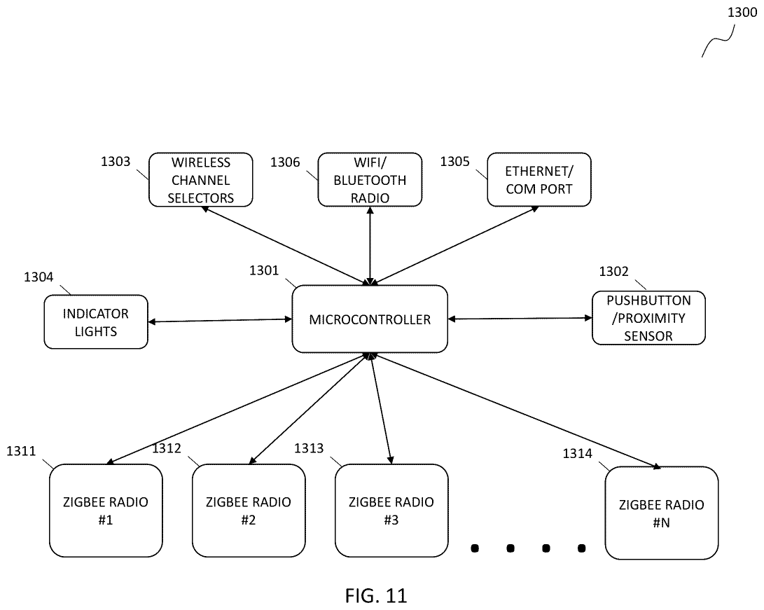

FIG. 11 shows an exemplary schematic of linker (410). Linker (410) may include a microcontroller (1301) operable to be in communication with one or more radios (each, e.g., a ZIGBEE radio or software-defined radio) (1311, 1312, 1313, 1314), a proximity sensor or consensus button (1302), a wireless channel ID selector (1303), lift set indicators (1304) for detailing communications between radio (1311, 1312, 1313, 1314) and controller (e.g., 1221, 1222, 1223, 1224), an ethernet and communication port (1305), and WIFI and BLUETOOTH radios (1306).

In some embodiments, radios (1311, 1312, 1313, 1314) may be enabled to be in communication with a peripheral component such as a set or multiple sets of lift columns (2), a lift column subgroup (9), multiple lift column subgroups (420), and a controller (e.g., controller (300) or controller (200)). As an example, radio (1311) may be capable of communicating via ZIGBEE specifications to transmit lift instructions and to receive position data from a set of lift column subgroups (9). In a further embodiment, radio (1311) may communicate over various frequencies so as to be at a different frequency from any other radio (e.g., 1312, 1313, 1314) in sufficient proximity to interfere with communications. Radios (1311, 1312, 1313, 1314) frequencies may be selectable and changeable via instructions from microcontroller (1301) based on an automated rule or a user selection of the channel ID.

In some embodiments, the channel ID and the frequency may correspond to an associated radio (1311) of a peripheral device such as in a controller (300). Radio (1311) may be in communication with microcontroller (1301) to communicate lift data and lift instructions. In some embodiments, linker (410) may include multiple radios (1311, 1312, 1313, 1314), where each radio is operable to communicate over a different frequency or frequencies from other radios. Linker (410) may alternatively or additionally include one or more software-defined radios that microcontroller (1301) manages in order to work with the other components of the system (1300). By using different frequencies, the available bandwidth for communicating with a set or multiple sets of lift columns (2) in the system (1300) increases. With the additional bandwidth, latency is reduced—and response speed is increased—when communicating to the set or multiple sets of lift columns (2) for equalized lifting, particularly with larger lifting systems (1200) (e.g., 18 lift columns (2) distributed amongst a set of lift column subgroups (9)).

In further embodiments, the linker (410) may have a consensus button (1302), which may be in communication with microcontroller (1301) to make microcontroller (1301) operable to send lift instructions to the radios (1311, 1312, 1313, 1314). In some embodiments, and as shown in FIG. 5, the consensus button (1302) may be physically attached to or part of linker (410) and located at a safe distance from all lift columns (2) such that a user may be required to be at that distance from the set of lift columns (2) to raise or lower the vehicle (450). This distance may be defined as a distance at which an operator may stand without injury should the vehicle (450) fall while being raised or lowered or while in a raised position. The predetermined distance may be defined, for example, as 1, 1.5, 2, 2.5, 3, or some other multiple of the height of the vehicle (450). In a further embodiment, the consensus button (1302) may be a pushbutton or toggle switch. In additional embodiments, a proximity sensor (1302) may be used to detect the location of a user or other individual near the linker (410) and/or relative to the lifts (2). Thus, in various embodiments, a consensus button (e.g., 513) may operate alone, one or more proximity sensors may operate alone, or both may operate in combination with each other.

In a further embodiment, the lifting system (100) may include a tracking module (not shown) that is configured to track a location of one or more critical objects in and around the lift area. By way of non-limiting example, the one or more critical objects may include one or more of at least one control device, the linker module (410), at least one lift group of the plurality of lift groups, at least one linking column of the plurality of linking columns, a person, an animal, or any other mobile object (e.g., mobile lifts, autonomous mobile devices, etc.). In some embodiments, the tracking module may be a real-time locating system (RTLS), which includes, but is not limited to active radio frequency identification (Active RFID), active radio frequency identification with infrared hybrid (Active RFID-IR), Infrared (IR), Optical locating, Low-frequency signpost, identification, semi-active radio frequency identification (semi-active RFID), passive RFID, steerable phased array antennae, radio beacon, ultrasound identification (US-ID). ultrasonic ranging (US-RTLS), ultra-wideband (UWB), wide-over-narrow band, wireless local area network (WLAN, Wi-Fi) tracking, personal area network (PAN) (e.g., Bluetooth) tracking, clustering in noisy ambience, bivalent systems, and the like.

In some embodiments, the location of the one or more of the critical objects (e.g., as determined by the tracking module) may be considered when evaluating the safety of operating the lift (e.g., a safety criterion). Thus, as discussed herein, (e.g., with reference to FIG. 8) if a message is intended for the linker (410) and includes a lift command, a check of the area (e.g., proximity check) is performed prior to executing the lift command. If it is determined that a critical object is in a potentially dangerous area (e.g., such that it may interfere with the lifts or be damaged by them) a corrective action may be taken, including, but not limited to, ceasing all lift movement on the combined groups of lift columns (420), lowering all lifts in the combined groups of lift columns (420), automatically adjusting for the determined offset, and providing a notification to a user (e.g., visual, auditory, haptic, etc.)

### III. System Implementation

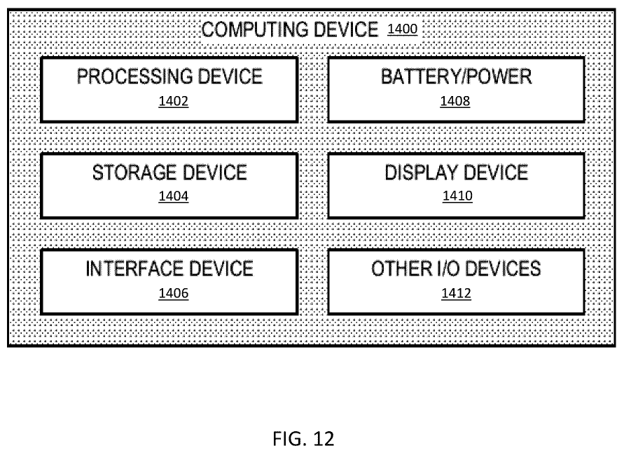

FIG. 12 is a block diagram of a computing device (1400) that may perform/support all or some of the methods disclosed herein, in accordance with various embodiments. In some embodiments, each controller (300) and linker microcontroller (1301) may be implemented by a single computing device (1400) or by multiple computing devices (1400). In some embodiments, and as shown, the computing device (1400) of FIG. 12 may have a number of components, but any one or more of these components may be omitted or duplicated, as suitable for the application and setting. In some embodiments, some or all of the components included in the computing device (1400) may be attached to one or more motherboards and enclosed in a housing (e.g., including plastic, metal, and/or other materials). In some embodiments, some of these components may be fabricated onto a single system-on-a-chip (SoC) (e.g., an SoC may include one or more processing devices (1402) and one or more storage devices (1404). Additionally, in various embodiments, the computing device (1400) may not include one or more of the components illustrated in FIG. 12, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device (1400) may not include a display device (1410), but may include display device interface circuitry (e.g., a connector and driver circuitry) to which a display device (1410) may be coupled.

The computing device (1400) may include a processing device (1402) (e.g., one or more processing devices). As used herein, the term “processing device” may refer to any device or portion of a device that processes electronic data from registers and/or memory to transform that electronic data into other electronic data that may be stored in registers and/or memory. The processing device (1402) may include one or more digital signal processors (DSPs), application-specific integrated circuits (ASICs), central processing units (CPUs), graphics processing units (GPUs), crypto-processors (specialized processors that execute cryptographic algorithms within hardware), server processors, or any other suitable processing devices.

The computing device (1400) may include storage device (1404) (e.g., one or more storage devices). Storage device (1404) may include one or more memory devices such as random-access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices.

In some embodiments, the storage device (1404) may include memory that shares a die with a processing device (1402). In such an embodiment, the memory may be used as cache memory and may include embedded dynamic random-access memory (eDRAM) or spin transfer torque magnetic random-access memory (STT-MRAM), for example. In some embodiments, the storage device (1404) may include non-transitory computer-readable media having instructions thereon that, when executed by one or more processing devices (e.g., the processing device (1402)), cause the computing device (1400) to perform any appropriate ones of or portions of the methods disclosed herein.

The computing device (1400) may include interface device (1406) (e.g., one or more interface devices (1406)). The interface device (1406) may include one or more communication chips, connectors, and/or other hardware and software to govern communications between the computing device (1400) and other computing devices. For example, the interface device (1406) may include circuitry for managing wireless communications for the transfer of data to and from the computing device (1400). The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. Circuitry included in the interface device (1406) for managing wireless communications may implement any of a number of wireless standards or protocols, including but not limited to IEEE standards including WI-FI (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.).

In some embodiments, circuitry included in the interface device (1406) for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device (1406) for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device (1406) for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device (1406) may include one or more antennas (e.g., one or more antenna arrays) to receipt and/or transmission of wireless communications.

In some embodiments, the interface device (1406) may include circuitry for managing wired communications, such as electrical, optical, or any other suitable communication protocols. For example, the interface device (1406) may include circuitry to support communications in accordance with Ethernet technologies. In some embodiments, the interface device (1406) may support both wireless and wired communication, and/or may support multiple wired communication protocols and/or multiple wireless communication protocols. For example, a first set of circuitry of the interface device (1406) may be dedicated to shorter-range wireless communications such as Wi-Fi or Bluetooth, and a second set of circuitry of the interface device (1406) may be dedicated to longer-range wireless communications such as global positioning system (GPS), EDGE, GPRS, CDMA, WiMAX, LTE, EV-DO, or others. In some embodiments, a first set of circuitry of the interface device (1406) may be dedicated to wireless communications, and a second set of circuitry of the interface device (1406) may be dedicated to wired communications.

The computing device (1400) may include battery/power circuitry (1408). The battery/power circuitry (1408) may include one or more energy storage devices (e.g., batteries or capacitors) and/or circuitry for coupling components of the computing device (1400) to an energy source separate from the computing device (1400) (e.g., AC line power).

The computing device (1400) may include a display device (1410) (e.g., multiple display devices). The display device (1410) may include any visual indicators, such as a heads-up display, a computer monitor, a projector, a touchscreen display, a liquid crystal display (LCD), a light-emitting diode display, or a flat panel display.

The computing device (1400) may include other input/output (I/O) devices (1412). The other I/O devices (1412) may include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device (1400), as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device (1400) may have any suitable form factor for its application and setting, such as a handheld or mobile computing device (e.g., a cell phone, a smart phone, a mobile internet device, a tablet computer, a laptop computer, a netbook computer, an ultrabook computer, an ultra-mobile personal computer, etc.), a desktop computing device, or a server computing device or other networked computing component.

Each patent, patent application, or other document identified herein is hereby incorporated by reference as if fully set forth.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions or other material directly set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions or other disclosure material set forth herein will only be incorporated to the extent that no conflict arises between that incorporated material and the existing disclosure material.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the claims and is understood not to be limited to the details of structure and operation shown and described in the specification and drawings.

What is claimed is:

1. A vehicle lift system, comprising:
a) a plurality of lift groups, each lift group comprising:
i) a plurality of lift columns configured to lift a vehicle, and
ii) a control device,
wherein at least a first control device of a first lift group in the plurality of lift groups is configured to receive input from a user; and
b) a linker module comprising a processor and a memory, wherein the memory is configured with programming instructions executable by the processor to:
i) receive a user command from the first control device, and
ii) instruct each lift group to execute the user command using a connection frequency, wherein the connection frequency is different for each lift group.

2. The vehicle lift system of claim 1, further comprising a consensus button, and wherein the programming instructions are further executable by the processor, responsive to receiving the user command, but prior to executing the user command, to:
a) if the consensus button is not activated, provide a notification to the user that the consensus button must be activated prior to executing the user command; and
b) if the consensus button is activated, instruct each lift group to execute the user command.

3. The vehicle lift system of claim 2, wherein the consensus button is a momentary switch.

4. The vehicle lift system of claim 1, further comprising a tracking module configured to track a location of each of one or more critical objects, the one or more critical objects being selected from the group consisting of: at least one control device, the linker module, at least one lift group of the plurality of lift groups, at least one lift column of the plurality of lift columns, and a living being, wherein the programming instructions are further executable by the processor to:
a) determine, based on the locations of the one or more critical objects, whether a safety criterion has been met or has not been met,
b) responsive to determining that the safety criterion has been met, execute the user command, and
c) responsive to determining that the safety criterion has not been met, provide a notification to the user that the safety criterion has not been met.

5. The vehicle lift system of claim 4, wherein the tracking module comprises a real-time locating system (RTLS).

6. The vehicle lift system of claim 1, wherein the linker module is further configured to:
a) receive information from a second control device;
b) determine, based on the information, whether the user command can be executed or cannot be executed,
c) responsive to determining that the user command can be executed, instruct each lift group to execute the user command, and
d) responsive to determining that the user command cannot be executed, provide a notification to the user.

7. The vehicle lift system of claim 1, wherein the connection frequency for each lift group is determined based on a transmission factor, the transmission factor being selected from the group consisting of: a user input, a user preference, an evaluation of potential radio frequency interference, a total number of lift groups, a total number of control devices, bandwidth usable in a particular frequency band, and historical metrics associated with a particular frequency band.

8. The vehicle lift system of claim 1, wherein the linker module further comprises a plurality of radios, and wherein each radio is configured to communicate with the control device of at least one lift group using the connection frequency of the corresponding lift group.

9. The vehicle lift system of claim 1, wherein the control device is selected from the group consisting of:
a) a wireless control device;
b) a mobile lift-mounted control device;
c) a stationary lift-mounted control device;
d) a wall-mounted control device;
e) a floor-mounted control device;
f) a ceiling-mounted control device; and
g) a wearable control device.

10. The vehicle lift system of claim 1, wherein the control device comprises a proximity sensor that produces an output, and wherein the programming instructions are further executable by the processor to determine, based on the output of the proximity sensor, a distance between the control device and one or more of the lift columns, wherein determining that the user command can be executed is further based on the determined distance.

11. The vehicle lift system of claim 1, wherein each of the lift groups consists of a number of mobile lift columns, and the number of mobile lift columns in each lift group is selected from the number group consisting of 2, 4, 6, and 8.

12. The vehicle lift system of claim 1, wherein the processor is further configured to:
a) determine whether the linker module is in communication with each lift group; and
b) responsive to determining that the linker module is not in communication with each lift group, make each lift column of the plurality of lift columns non-operable.

13. The vehicle lift system of claim 1, wherein the processor is further configured to:
a) receive offset data associated with each active lift column in each lift group, and
b) determine, based on the offset data, an offset value for each active lift column, wherein the instruction to each lift group is adapted as a function of the offset values to ensure lifting stability.

14. The vehicle lift system of claim 1, wherein one or more lift columns of the plurality of lift columns is configured to be horizontally movable relative to any other lift column of the plurality of lift columns.

15. The vehicle lift system of claim 1, wherein each lift column from the plurality of lift groups is of a lift type selected from the type group consisting of: parallelogram lift, cylinder lift, scissor lift, screw lift, in-ground lift, and above-ground lift.

16. A system comprising:
a) a processor associated with a computing device; and
b) a non-transitory, processor-readable storage medium, wherein the non-transitory, processor-readable storage medium is encoded with one or more programming instructions that, when executed, cause the processor to:
i) receive at least one user command from a control device of at least one of a plurality of lift groups, wherein each lift group comprises a plurality of lift columns, the plurality of lift groups is configured to together lift a vehicle, and the control device in each lift group is in communication with each lift column in said lift group to coordinate said lifting; and
ii) via communication using a connection frequency, instruct each lift group to execute the user command, wherein the connection frequency is different for each lift group.

17. The system of claim 16, further comprising a consensus button having an activated state and a not-activated state, and wherein the instructions, when executed, also cause the processor to respond to receiving the at least one user command by:
a) if the consensus button is in the not-activated state, provide a notification to the user that the consensus button must be activated prior to executing the at least one user command; and
b) if the consensus button is in the activated state, executing the at least one user command.

18. The system of claim 16, wherein the programming instructions, when executed, also cause the processor to:
a) interact with the control device of each lift group using an interaction method;
b) determine, based on the interaction, whether the received command can be executed;
c) responsive to determining that the received command can be executed, send an instruction to each lift group to execute the received command; and
d) responsive to determining that the received command cannot be executed, provide a notification to the user.

19. The system of claim 18, wherein the interaction method is an actively requesting method.

20. The system of claim 19, wherein the actively requesting method is polling.

21. The system of claim 16, wherein the processor is further configured to render each lift column of the plurality of lift columns non-operable for lifting whenever the processor is not in communication with each lift group.

22. The system of claim 16, wherein the processor is further configured to:
a) receive offset data associated with each active lift column in each lift group, and
b) determine, based on the offset data, an offset value for each active lift column, wherein the instruction to each lift group is adapted as a function of the offset values to ensure lifting stability.

23. The system of claim 16, wherein the system further comprises a plurality of radios, and wherein each radio is configured to communicate directly with a specific lift group.
